(19) United States
(12) Patent Application Publication
(10) Pub. No.: US 2011/0258979 A1
(43) Pub. Date: Oct. 27, 2011

(54) Cotton Stalk Removal Apparatus

(76) Inventor: John A. Darden, Lenox, GA (US)

(21) Appl. No.: 12/911,721

(22) Filed: Oct. 25, 2010

Related U.S. Application Data
(60) Provisional application No. 61/254,654, filed on Oct. 23, 2009.

(51) Int. Cl. A01D 34/42

(52) U.S. Cl. 56/504

(57) ABSTRACT

A cotton stalk remover apparatus is provided for attachment to a cotton harvesting machine. The removal apparatus is placed in-line behind each harvesting head or operated as a separate machine. The removal apparatus includes a blade section having a rotating blade that lifts and damages cotton stalks. The cotton stalks are released rearward from the blade section assisted by the rotating blade. The blade may have four peripheral blades, and the blade may be assisted in ejecting the cotton stalks by an directional device section having a rotating walker or alternatively a spiral auger that moves the top section of cotton stalks downward and rearward. The lifting and de-rooting of the cotton stalks by the blade may be assisted by a pulling section that includes rotating spindles with spiral flanges that grab, lift and release the stalks immediately prior to the stalks entering the blade section.

### PRIORITY CLAIM

The present application claims benefit of U.S. Provisional Application No. 61/254,654 filed on Oct. 23, 2009.

### BACKGROUND OF THE INVENTION

1. Field of the Invention

The present invention relates to an apparatus for removal of cotton stalks after harvesting of cotton by attachment of the apparatus in serial arrangement rearward of a cotton harvester head.

2. Brief Discussion of the Prior Art

Cotton is picked using a harvester having heads for picking several rows at once, usually four to eight rows. After cotton is picked, the stalks are left in the field and require additional processing for removal so that a subsequent crop can be planted. Further, cotton is a perennial plant and can re-grow following harvest, providing the potential for development of hostable fruit (squares and bolls) for boll weevil feeding and reproduction. Under good environmental conditions, cotton plants can generate hostable fruit in three to four weeks. Thus, it is considered important to destroy cotton stalks as soon as the crop has been harvested to aid in reducing costs for the boll weevil eradication. Present practices require several passes by mowers and disc harrows to effectively process these stalks. These several passes cause wear and tear on expensive cotton harvesting machines and require the use of fuel that is costly and harmful to the environment. Thus, what is needed is a method for removal of cotton stalks more efficiently.

An attempt has been made to remove cotton stalks by pulling up the stalks using a separate machine after harvesting of the cotton. Using this prior method, the stalks are pulled and left lying straight and otherwise unprocessed on the ground. This method still requires the use of fuel and a separate machine to pull the stalks and requires some degree of harrowing to process the stalks because of the unprocessed condition the stalks are left on the ground. Herbicides are also used to destroy cotton stalks but requires the use of legal products at the associated costs. Further, the cotton crop stubble must be processed by shredding to a desired height before applying the herbicide for obtaining the desired results. To achieve effectiveness, some growers have gone to great lengths to mount spray booms directly on their flail shredders and band the herbicide during the shredding operation. This is effective to destroy the cotton stalks but still requires the additional operations in the field with the associated equipment and fuel use and also requires the use of unnecessary herbicides, which requires close monitoring for drift.

### SUMMARY OF THE INVENTION

The present invention provides a method and apparatus for processing of crop stubble, in particular, cotton stalks, simultaneous with the process of harvesting. Thus, the present invention saves time, labor, fuel and decreases harm to the environment by reducing carbon emissions.

The cotton picker stalk eliminator kit is designed to be attached to the rear of the cotton picker harvesting head on a cotton harvester. The kit provides a housing in alignment with the channel that the cotton plants exit the picker head. The kit is driven by the cotton picker head in relationship to the head speed so the speed of the kit is always in proper relation to the picker head speed and thereby in relation to ground speed. As the cotton stalk exits the harvesting spindle area, and the cotton has been removed by the picker head, the stalk moves through the exit of the picker head and into the housing of the stalk eliminator apparatus. The cotton plant stalk will then come in contact with the blade, preferably one or more peripheral blades with four cutting edges on each. The blades lift the cotton stalks from the root and damage the stalks significantly. Some short stubble that does not effect future planting preparation may be left in the ground.

The upper part of the cotton plant is loosened and contacts a directing device that moves the upper portion of the plant stalk downward toward the blade area. The directing device includes a selection of a fixed angled member, a rotating walker, or tapered angled auger. In one embodiment, a rotating walker includes arms that engage the stalk as the walker turns to move the stalks downward and releases the stalks as the arms rotate through them. In another embodiment, an auger angles downward toward the rear of the harvester and upward toward the picking heads. The auger may protrude into the picking head where it will first contact the cotton plant. The auger causes the upper portion of the cotton plant stalk to move downward as it moves to the rear of the eliminator housing where the stalk is fed into the blade or blades. As the upper portions of the stalks fall into the blade with the assistance of the directional device above, the blade further damages or breaks up the stalk. The combination of the directional device and blade ejects the stalk rearward of the eliminator housing.

### BRIEF DESCRIPTION OF THE DRAWINGS

FIG. 1 is a perspective view of a cotton harvesting machine with a cotton stalk eliminator in accordance with the invention.

FIG. 2 is a side view of a cotton harvesting machine with a cotton stalk eliminator.

FIG. 3 is a side view of the cotton stalk eliminator in relation to a portion of a cotton picking head in a first embodiment of FIG. 2.

FIG. 4 is a side view of a cotton stalk eliminator on a cotton harvesting machine in an alternative embodiment.

FIG. 5A is a side view of the cotton stalk eliminator in relation to a portion of a cotton picking head in the alternative embodiment of FIG. 4.

FIG. 5B is a side view of the cotton stalk eliminator in relation to a portion of a cotton picker head in another alternative embodiment.

FIG. 6 is a top view of a pulling portion of the cotton stalk eliminator in a first position as accomplished in one embodiment of the apparatus.

FIG. 7 is a top view of a pulling portion of the cotton stalk eliminator in a second position as accomplished in the embodiment of FIG. 6.

FIG. 8 is a side view of an embodiment of the cotton stalk eliminator.

FIG. 9 is a perspective view of the drive pulleys of the cotton stalk eliminator in one embodiment.

### DETAILED DESCRIPTION OF THE INVENTION

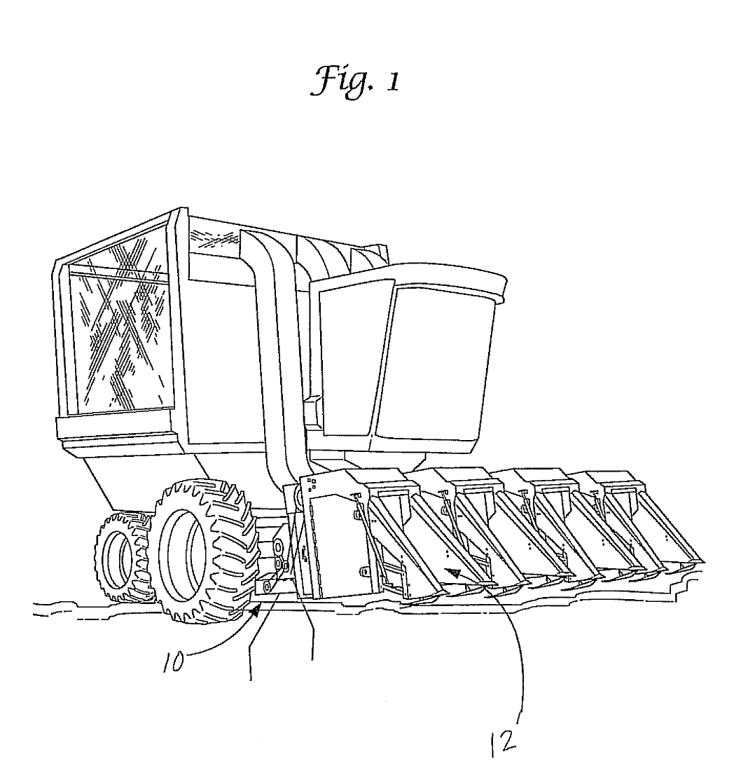

A stalk removing apparatus 10, i.e. cotton stalk eliminator, is provided as shown in FIG. 1 that is situated behind each harvesting head 12 of a cotton picker. The stalk removal apparatus provides a device used in a method for destruction of crop stubble and, particularly, for the removal of cotton stalks. Cotton is harvested from the plants, and the stalks 14 enter into a housing 16 of the stalk removing apparatus. The stalk removing apparatus comprises a rotating blade section 18 that includes at least one blade 20 that is driven by the drive of the cotton harvesting apparatus. The rotating blade processes stalks immediately after harvesting by significantly damaging the stalks and at least partially de-rooting most of the stalks making further processing by mowing and additional disc harrowing during planting preparations unnecessary. In addition, the stalk removing apparatus may include a directional device section 22, that includes embodiments having a rotary auger 24 or a walker 25 that directs the stalks downward into the stalk eliminating blade and rearward of the stalk removal apparatus. The stalk removing apparatus may also include a pulling section 26 that will assist in de-rooting the stalks prior to assist in processing of the stalks by the blade section.

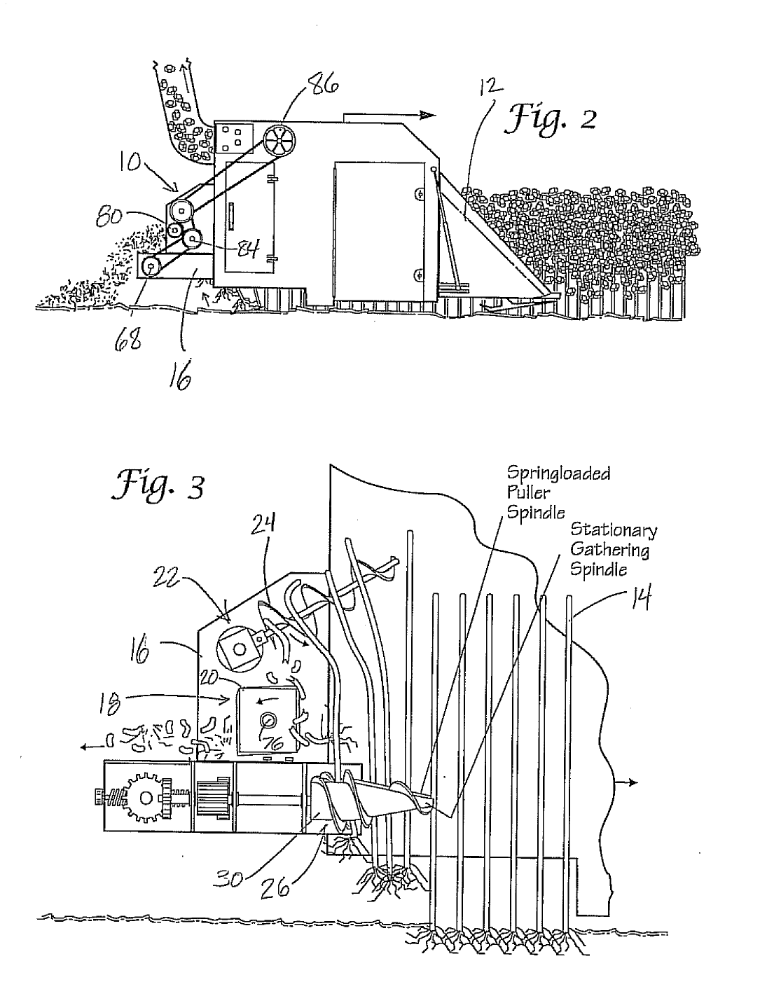

In a first embodiment shown in FIG. 2 and FIG. 3, the stalks enter the housing and are received between two cooperating spindles 28, 30. These spindles are comprised within the optional pulling section that assists in de-rooting the stalks from the ground. The stalks are pinched between the spindles by cooperating flanges/spirals 32, 34 on each spindle which turn in sync. The opposing spirals meet in timed sequence and provide about a ⅛″ clearance between the spindles that grab the stalk, which is usually about ½″ to ¾″ thick.

The first spindle 28 has shaft 36 that is spring biased and can allow the spindle to move toward rear and allow for the thickness of stalk, the tension of the spring 38 holds the stalk so that the spindles grab the stalk between the two flanges, the movement of spindle allows for operation on the stalk by squeezing and pulling. The first spindle flange 32 releases the stalk first by running out of spiral in pre-sequence with the second spindle flange spiral 34. Meanwhile the second spindle flange spiral receives another stalk during continued operation of the previously received stalk, such that the processing of stalks is continuous and rapid. The second spiral includes a kicker lip 40 at the end of the spiral 34 that ejects the stalks through a gap between the spindles from the area between the spirals. When pulling the stalk, the spirals generally run about ⅛″ from each other. As the spindles turn each stalk is lifted about 2-3 inches by the grabbing action and then release the stalk. The stalk is generally still in the ground after processing by the puller section, but pulled loose for effective operating by the blade section and directional device section. The spindles move about 52 rps and could theoretically remove up to 52 stalks per second, but in reality stalks are generally fed about 10 stalks per second.

The first spindle 28 is preferably arranged parallel to the second spindle 30. The first spindle includes a shaft 36 that runs through a first rear chamber portion 44 of a gear box 42 and into the second rear chamber portion 46. The shaft is arranged with the spring 38 in the second rear chamber. The first spindle is further slidably attached to the gear box via a first bearing 48 for additional support. The first bearing moves with the shaft, and the first spindle is provided a second bearing support 50 with the shaft within the first rear chamber portion. The second bearing also moves with the shaft within the chamber. The spring does not push on the bearings since it moves with the shaft. The spring is arranged to only press against the shaft. An adjustment means 60 is provided on the exterior of the gear box for adjusting the spring tension on the first spindle shaft. The chambers of the gear box housing are deep enough and long enough to accommodate the longitudinal movement of the bearings.

The second spindle includes a shaft 62 that runs through the first rear chamber portion 44 of the gear box and into the second rear chamber portion 46. The shaft of the second spindle 30 includes a gear 64 that sets with a drive gear 66 that is attached to a pulley 68 and belt system. The shaft thus rotates to drive the second spindle and the timing gears 70, 72, which in turn will drive the first spring loaded spindle 28.

Both spindles include spiral flanges 32, 34 with either square or rounded edges 74. Square edges have been found especially effective in pulling and gripping cotton stalks. The heads of the spindles are conical to effectively receive stalks and move them into the spiral areas of the spindles. The heads are arranged in the apparatus housing with the stalks being forced into the area between the spindles. The spiral flanges are made of hardened material to minimize wear.

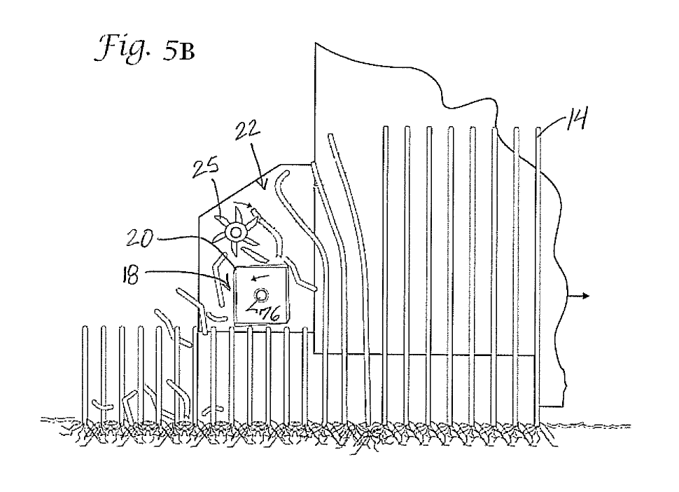

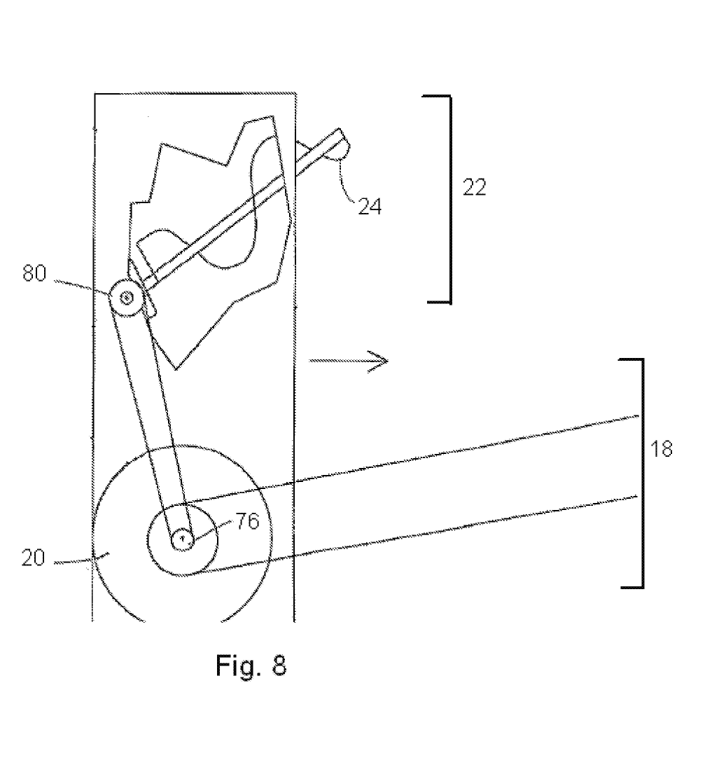

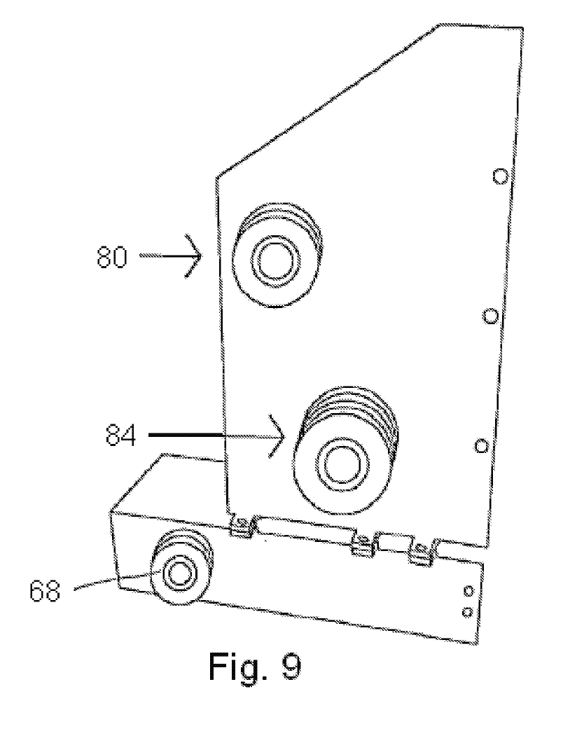

The blade, or several blades arranged side by side, is situated above and slightly behind the spindles of the puller section and rotates counter-clockwise, typically 3000-4000 rpm on a belt-driven shaft 76. When the puller section 26 is not included as shown in FIGS. 5A, 5B and 8, the blade section 18 and the blade 20 may be lowered and arranged behind the cotton picker head closer to the ground. The stalk pulling spindles or alternatively, peripheral blade, are situated about 3″ off of the ground. The counter-clockwise rotation of the blade causes a upward lifting, cutting, and rearward. The blade grabs the stalks and pulls them up further and over and rearward. The blade is situated within a housing having parallel sides that form a chamber for the blade to receive the stalks. The blade fills a sufficient portion of the housing that stalks are forced into contact with the blade as they travel through the chamber of the stalk removing apparatus. A peripheral blade as shown in FIGS. 3 and 5A, 5B is the preferred blade for operation on the stalks because of it's durability, ease of arrangement within the housing and effectiveness in pulling and processing stalks. The peripheral blade works well because it does not mow off the tops of the stalks, but instead gnarls, lifts, removes and ejects the stalks rearward. Further, the peripheral blade may include several, typically four, cutting edges for efficient processing of stalks. Usually, this will provide about 12,000 or more strikes per minute on the stalks being processed. The blade helps to eject the stalk by pulling around, above and ejecting behind the blade. Anything above the blade is moved rearward and ejected by the directional device such as a walker or auger. In one preferred embodiment, the peripheral blade is comprised on two sections that are joined by attachment to each other to form a central shaft hole. The two-part blade allows for easier installation and repair of the peripheral blades.

The directional device section is situated above the blade and includes a directional device such as a rotating walker wheel that rotates in the opposite direction of the rotating blade or an auger directed downward at about a 45 degree angle toward the rear of the cotton machine as shown in FIG. 3.

The auger shown in FIG. 5A is angled upward and forward toward the top of the cotton machine and includes a shaft 78 with a spiral flange 24 arranged around the shaft to form the auger body. The auger includes a gear and is driven by a pulley 80 and belt system to rotate rapidly. The auger turns and the spiral of the auger brings the top of the stalk downward. Many of the cotton stalks are generally very tall, and the auger is effective in pulling the tops of the tall stalks downward into the area of the blade section or above the blade for ejection from rearward of the blade and auger. The auger is effective in moves the stalk that otherwise would have a tendency to remain static. Stalk is spit out from the stalk removal apparatus between the auger and the blade gang for the blade.

The auger does not work successfully in all circumstances, and a stalk walker shown in FIG. 5B may be preferable to the auger. Like the auger, the walker is situated above the blade in the directional device section of the apparatus. As the blade turns in a first direction to lift and shred cotton stalks as they are fed from the picking chamber, the walker provides a wheel-like device that turns in an opposite second direction. The walker pushes the upper portions of the stalks downward and rearward into the blade area so that the stalks are further processed by the blade and whereby the stalks do not jam inside of the stalk eliminator apparatus. The shape of the walker is designed to prevent wrapping of the stalk with the walker. The walker includes several arms extending from a central hub where the walker is mounted on a pulley driven shaft. The arms include first edge that rotates clockwise and represents the leading edge as stalks enter the apparatus. The first edge pushes the stalks downward. In a particular embodiment the first edge is curved to improve the walker and further prevent wrapping of stalks on the walker's arms.

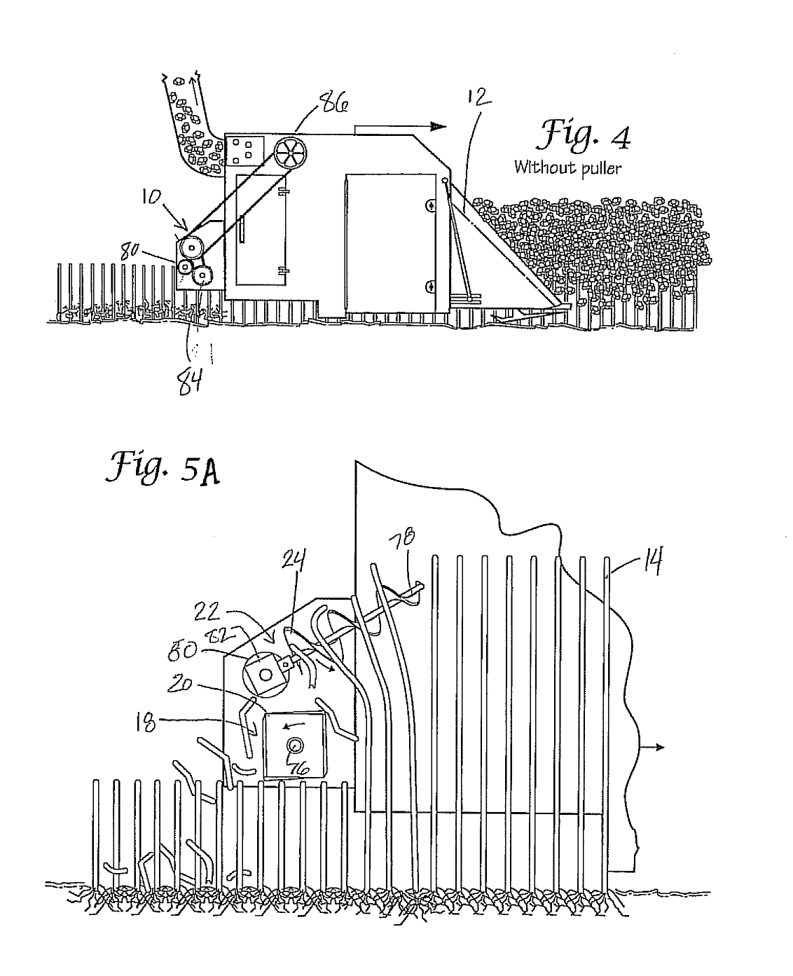

The spindles of the pulling section, the blades and the directional device are preferably driven by belts and pulleys in arrangement with gears as shown in FIGS. 2, 4 and 7. In one particular embodiment, a gear box 42 is arranged behind the spindles, another gearbox 82 is arranged for driving the auger of each stalk removing apparatus. In another embodiment, a reversing unit of gears or pulleys drive a directional device comprising a walker in the opposite direction of the blade.

A stalk removal apparatus 10 is arranged behind each harvesting head 12. Each stalk removal apparatus may be provided as a kit with a housing that attaches to a plate on the rear of a cotton picker harvesting head. Attachment members such as bolts or clips may hold the apparatus 10 onto a preexisting plate and guide bar on the picker. As the stalk removal apparatus 10 rests on the harvesting head, no more than 2-4 clips or attachment points are required to retain the stalk removal apparatus, and several may be assembled onto a picker in a reasonably short time, or removed.

As shown in FIGS. 2, 4 and 8 the pulley 84 for the blade has additional V's for attaching pulleys that also connect to the pulley 86 from the drive (i.e. off of machine's standard drive line coming off of drive shaft of machine—driven by same hydraulics that drive the picker), a pulley 80 for an auger, or a pulley and reversing unit for a walker, and an optional pulley 68 for the spindles. Belts are connected (a) between the main drive and blade drive, (b) between the spindle drive and blade drive, (c) between the auger drive or walker drive and blade drive. The stalk eliminating apparatus is adaptable to be driven from the left-hand side of the apparatus or the right-hand side of the apparatus according to the arrangement of the power take-off on the particular picker. In particular, an additional reversing unit may be provide for use in combination with the stalk removal apparatus when used with a right-hand side power take-off.

Each picker head will include a stalk removal apparatus as an addition to the harvester. The harvesting machine may include several heads according to the number of rows to be picked by the machine, typically from 4-8 heads.

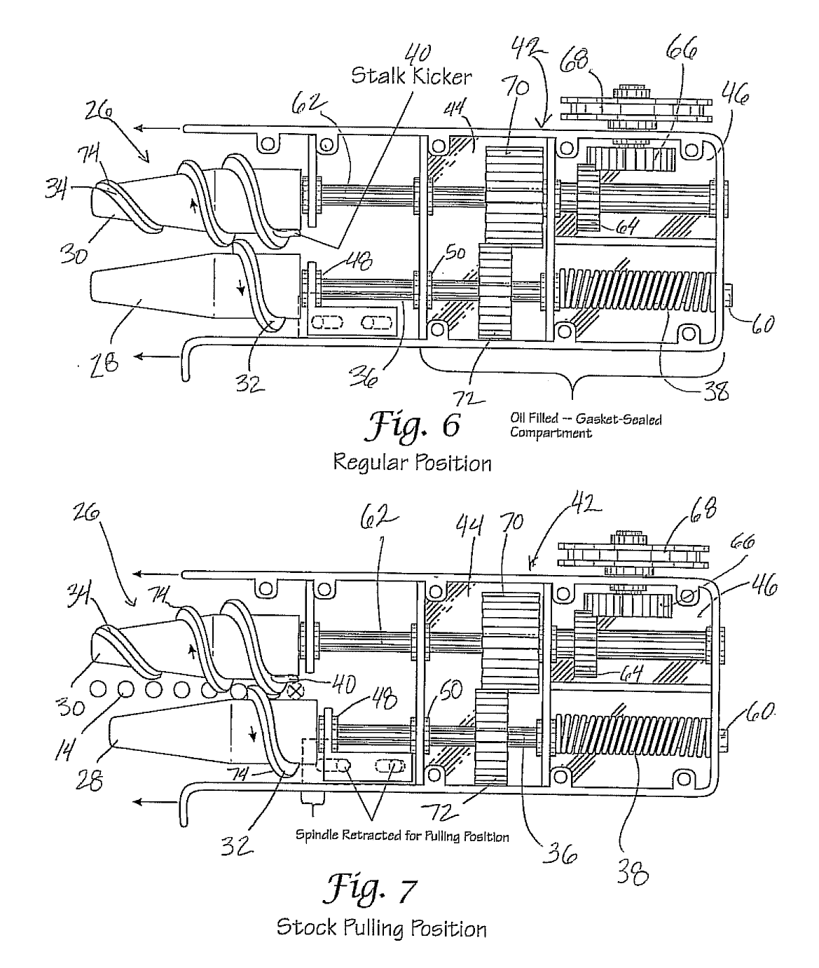

In a further embodiment of the stalk removal apparatus, a pulling section is included having a device for pulling stalks out of the ground. In the exemplary embodiment a gear box for the spindles is shown in FIGS. 6 and 7 in alternative positions with the cover cut-away for depiction of details. The gear box for the spindles is covered, and the rear portion of gear box is sealed and running in oil. The bearings associated with the spindles are also sealed. The device is arranged with sealed bearings and sealed drive gears and timing gears to resist wear and tear while running in dirt. A set of timing gears in a first rear chamber portion and a set of 90 degree drive gears is behind the timing gears in a second rear chamber portion. The timing gears include a full length gear 70 on the shaft for the second spindle, and a half-length gear 72 on the shaft for the spring loaded first spindle. The half-length gear allows for the rearward movement of the spring loaded first spindle while maintaining the timing gears in operable relation to each other. The drive gears are attached with a pulley to a belt drive that connects to the pulley for the blade.

A belt tensioning unit may be provided in combination with the belt driven pulleys to improve the performance of the apparatus through easy adjustment of belt tension. As shown, the pulley and shaft for blade drive is attached by a slotted bracket to the housing of the stalk removal apparatus. The slotted bracket allows for an attachment that can be loosened for adjustment of the blade pulley. The blade pulley is moved forward in the slot to tighten the belts.

It is contemplated that the stalk removal apparatus may be operated independent of a cotton picker apparatus. For example, the cotton stalk removal apparatus could also be mounted on the underside of a cultivator frame with a drive on each unit. In this arrangement, the stalk removal apparatus could be operated as a distinct machine that is driven through a previously picked cotton field to mow the remaining stalks. In this embodiment, it may be even more advantageous to add some additional complexity and operation to the machine by including the pulling section with the stalk removal apparatus. In this configuration, the apparatus would include a stalk pulling device such as the spindles, whereby the apparatus would operate to both pull remaining stalks out of the ground and shred those stalks. This alternative independent operation would overcome the difficulty of including a pulling section under a cotton picker that works well within the various constraints imposed by the environment of the cotton picker harvesting heads. Therefore, if desirable to pull stalks out of ground, then the stalk removal apparatus may be provided as a separate cultivator mounted unit. A second cutting blade may be mounted above the first blade within the stalk removal apparatus when used as a separate machine mounted on a cultivator unit. Such a stalk removal apparatus with pulling section and additional blade would be a more complicated and more expensive, but may be preferred where more complete removal and obliteration of cotton stalks is desirable.

As the stalk removal apparatus operates, the stalks are wadded up, chewed up, broken up into segments, bent, folded, or scraped to cause extensive damage to the stalks. Such damage promotes the break-down of the stalk remains. Once treated by the stalk removal apparatus, the stalks lie in the sun and dry out over time. Usually, a reasonably small time in the sun will cause the stalks to begin disintegrating in their damaged condition. Whereas, if the stalks were only pulled out of the ground and left lying straight, a typical pass with a disc harrow will not sufficiently break up the stalks effectively. Instead, such straight and undamaged stalks, choke up on the harrow as the stalks wad up in front of the harrow. When pre-treated with the process of the present invention using the stalk removal apparatus in-line with the cotton harvester heads, the wadded up and damaged stalks are easily broken up by a single pass with a disc harrow during normal preparation for planting of a new crop.

The elimination of additional steps for removal of cotton stalks saves significant amounts of fuel and reduces carbon emissions. Usually as many as three additional trips about the field for mowing stalks and using a disc harrow are eliminated. The trip savings also eliminates the need for additional expensive equipment such as large stalk mowers, and the trips savings decreases the use of expensive tractors and accessories reducing wear and tear and the expense of repair and replacement.

1. A method for processing crop stubble including the steps of
receiving the crop stubble into a housing;
providing a vertically oriented blade rotating counterclockwise on horizontal shaft within the housing;
providing a directional device above a blade;
the directional device moving an upper portion of the crop stubble downward toward the blade;
the blade cutting and shredding the crop stubble to destroy the crop stubble; and
the blade and directional device discharging the destroyed crop stubble rearward from the housing.

2. A method for processing crop stubble as in claim 1 including the additional step of attaching the housing behind the harvesting head of a cotton picker and rotationally driving the directional device and the blade in opposite directions by attaching each to a power take-off of the cotton picker.
